(19) United States
(12) Patent Application Publication
(10) Pub. No.: US 2022/0126372 A1
(43) Pub. Date: Apr. 28, 2022

(54) A PRODUCT AND METHOD FOR POWDER FEEDING IN POWDER BED 3D PRINTERS

(71) Applicant: THE PROVOST, FELLOWS, SCHOLARS AND OTHER MEMBERS OF BOARD OF TRINITY COLLEGE DUBLIN, Dublin 2 (IE)

(72) Inventors: Rocco LUPOI, Dublin (IE); Ramesh PADAMATI, Dublin 2 (IE)

(73) Assignee: THE PROVOST, FELLOWS, SCHOLARS AND OTHER MEMBERS OF BOARD OF TRINITY COLLEGE DUBLIN, Dublin 2 (IE)

(21) Appl. No.: 17/429,838

(22) PCT Filed: Feb. 11, 2020
(86) PCT No.: PCT/EP2020/053507

§ 371 Date: Aug. 10, 2021

(30) Foreign Application Priority Data
Feb. 11, 2019 (EP) 19156529.0

(51) Int. Cl. B22F 12/50; B22F 10/20; B22F 12/42; B22F 7/02; B22F 5/00; B22F 3/22

(52) U.S. Cl. CPC B22F 12/50; B22F 10/20; B22F 12/42; B33Y 10/00; B22F 5/006; B22F 3/227; B22F 7/02

(57) ABSTRACT

The present invention provides a metal powder-polymer matrix film for use in delivering metal powder to a three-dimensional printing process, the matrix comprising at least one metal powder and a polymer sheet, wherein the metal powder is incorporated within the polymer sheet architecture or on the polymer sheet surface, and wherein the polymer sheet has a thickness that is at least half that of the powder thickness.

### FIELD OF THE INVENTION

The invention relates to a method of delivering powder for 3D printing (Additive Manufacturing—AM) in powder bed machines such as Selective Laser Melting (SLM) and a tape formulation for providing the powder.

### BACKGROUND TO THE INVENTION

The earliest use of Additive Manufacturing (AM) was in rapid prototyping (RP) during the late 1980s and early 1990s. Prototypes allow manufacturers a chance to examine an object's design more closely and even test it before producing a finished product. RP allowed manufacturers to produce those prototypes much faster than before, often within days or sometimes hours of conceiving the design. In RP, designers create models using computer-aided design (CAD) software, and then machines follow that software model to determine to the best way to construct the object. The RP concept has recently evolved to the principles of 3D Printing (or AM), featuring important advantages over more conventional manufacturing such as design complexity, no tooling, product customization, limited waste, reduced inventory.

In conventional 3D printing powder bed machines, powder is delivered to the working area from large tanks, any by spreading the particles using a blade or a roller over a large or smaller area. At this stage a laser (or an electron beam) will melt/consolidate a section of the layer. A new powder layer is therefore laid out and the process repeats until the full geometry of a part is formed. The powder layer thickness varies between 40 to 100 μm approximately in each run.

When considering AM of metallic materials, there is no doubt that Powder Bed Fusion (PBF) processes, and in particular Selective Lased Melting (SLM), stand out in comparison to the other due to the most optimal combination of process flexibility, parts quality (low porosity, high geometrical accuracy, etc.) and materials capabilities. As an example, in SLM, powder is delivered to the working area from large tanks, and the particles are spread out using a blade or a roller over a large or smaller area. At this stage, a laser will melt/consolidate a section of the layer. A new powder layer is therefore laid out and the process repeats until the full geometry of a part is formed based on the details stored in an STL file. The powder layer thickness (per each layer) varies between 40 to 100 μm approximately. Large starting amounts of powder are always required, and despite the component size (small or large), the entire powder bed (or build plate) needs to be covered. This leads to large quantity or stock material being sieved and recycled after any print (small or large). Also, due to nature of the blade spreading mechanism, the thickness of the powder bed is, in practise, not uniform and subject to constant re-adjustments during the laser scans. This leads to critical process inconsistencies across the build platform and lends itself to process repeatability issues. Despite the given tag of “first in class”, the current way powder is fed onto the bed area, and kept in place during the laser processing, has inherently strong process limitations that are challenging to solve.

US2017274595 describes involves inserting a stack of build plate sheets into a material feeder, transferring a sheet of the stack from the material feeder to a printer, depositing fluid on the single sheet while the sheet rests on a printer platen, transferring the sheet from the printer to a powder system, depositing powder onto the single sheet such that the powder adheres to the areas of the sheet onto which the printer has deposited fluid, removing any powder that did not adhere to the sheet, melting the powder on the build plate, and repeating the steps for as many additional sheets as required for making a specified 3D object. US20170157841 describes a system that includes a build platform, a recoater for dispensing build powder onto the build platform, an energy source, a foil feed assembly, and a controller for controlling actuation of these components. The method of forming the 3D item comprises depositing a layer of build powder onto the build platform surface, melting selected portions of the layer of build powder, applying a sheet of foil over the layer of build powder, melting selected portions of the sheet of foil onto the layer of build powder, removing the sheet of foil from the layer of build powder, and then lowering the build platform surface to prepare for deposition of a next layer of the build powder. However, the problems with the systems and methods described in the US patent documents are that thin sheets of printed metal are not achievable and bulk metallic sheets are rigid and difficult to adapt to the support surface when printed. In addition, welding of a metallic sheets is likely to require more energy input, returning higher residual stresses due to enhanced thermal gradients.

US 2018/514946 describes rigid, pre-patterned, metal powder-polymer matrix films for use in 3D printing. US 2016/101470 describes the use of multiple lasers and sintering steps to produce a 3D object using a sintering material (metal powder and a binder kneaded into a sheet shape on a stage). Giraud et al. (Thermal Spray 202, pp. 265-270 (2012)) describes the use of cold spray in the metallization of low-temperature resistant materials such as organic composites, for example, the metallization of PA66-matrix composites with aluminium. Lupoi R. et al. (Surface and Coatings Technology, vol. 205(7), pp. 2167-2173 (2010)) describes the use of cold spray to produce metallic coatings on non-metallic surfaces such as polymers and composites. WO 2018/143292 describes a method of manufacturing a laminated 3D object using a plurality of pre-patterned foils, some of which may include a metal.

It is an object of the present invention to overcome at least one of the above-mentioned problems.

### SUMMARY OF THE INVENTION

This invention describes a novel way of delivering powder for 3D printing in powder bed machines that radically differs from the conventional way of doing it. Metal powder is closely packed and embedded or attached within a thin polymer sheet, whose thickness is slightly larger than that of the diameter of the metal powder particles. This thin sheet forms a single ‘2D layer’. A laser beam, fired from above the 2D layer, is then used to vaporise the polymer binder, and then melt (sinter) the metal particles together. After sintering, the metal particles solidify instantaneously. A new 2D layer, or unused portion of the already employed 2D layer, is then placed directly on top of the previously printed layer, and this new layer or unused portion of the already employed 2D layer, is then also melted. Upon melting, this layer consolidates with the previously melted layer underneath. This process is repeated multiple times until the 3D part is manufactured from multiple 2D sheets (if required). The first 2D layer is built onto a metallic build plate, or similar, which can be removed post build. The method is suitable for retrofitting to existing PBF machines printing both large and small parts at the same time, can process multi-materials, and has minimum powder handling.

The 3D part is generated from a metal powder-polymer matrix film that is flexible and adaptable to be mounted on a roller and delivered to the 3D printer as a continuous roll of film. The films of the claimed invention are cost-effective, flexible and recyclable. In some instances, they are biobased and biodegradable. The fact that the film is formed as a continuous flexible sheet means that the user can avail of all of the area of the sheet when a 3D part is being printed by moving the build plate relative to the flexible film or moving the flexible film relative to the build plate.

According to the present invention there is provided, a metal powder-polymer matrix film for use in delivering metal powder to a three-dimensional printing process, the matrix comprising at least one metal powder and a polymer sheet, wherein the metal powder is incorporated within the polymer sheet architecture or on the polymer sheet surface, and wherein the polymer sheet has a thickness that is at least half that of the powder thickness.

According to the present invention, there is provided, a set out in the appended claims, a metal powder-polymer matrix flexible film for use in delivering metal powder to a three-dimensional printing process, the matrix comprising at least one metal powder and a polymer sheet, wherein the metal powder is incorporated within the polymer sheet architecture or on the polymer sheet surface; and wherein the flexible film comprises at least 90 wt % of the metal powder.

In one aspect, the thickness of the matrix is between about 1 μm to about 150 μm. Preferably, the thickness of the matrix is between about 5 μm to about 100 μm.

In one aspect, the polymer is selected from the group comprising a thermoplastic, epoxy, silicone, vulcanised rubber, polyester, polyurethane, polyethylene, polypropylene, polyamide, polyetheramide, polyvinylchloride (PVC), polyvinylidene fluoride (PVDF), a fluoroplastic, polylactic acid (PLA), polycaprolactone (PCL), polybutylene succinate (PBS), polyhydroxyalkanoate (PHA), and poly(3-hydroxybutyrate-co-3-hydroxyhexanoate) and combinations thereof.

In one aspect, the metal is selected from the group comprising stainless steel, tungsten, titanium, titanium alloys, aluminium, aluminium alloys, copper, nickel, nickel alloys, super alloys, high entropy alloys, cobalt-chrome, barium, molybdenum, NiTi (nitilon), NiTi alloys, ceramic materials, metal-ceramic composites, metal-diamond composites, tantalum, tantalum carbide, and combinations thereof.

In one aspect, the metal powder is embedded within the polymer sheet architecture.

In one aspect, the metal powder particles are closely packed and attached to one side of the polymer sheet. In this aspect, the thickness of the polymer sheet and attached metal powder particles together are larger than the diameter of the metal powder particles.

In one aspect, there is provided a method of manufacturing the metal powder-polymer matrix film described above, the method further comprising mixing the metal powder with the polymer in a ratio of about 4:1 to form a mixture and forming the metal-powder matrix film. Typically, the method includes extruding the mixture to form the metal powder-polymer matrix film.

In one aspect, when the metal powder is incorporated within the polymer sheet architecture, the metal powder-polymer flexible film is formed by solvent casting, thermal hot pressing, extrusion techniques or by joining a number of thin layers of metal-containing polymer sheets together.

Preferably, when the metal powder is on a surface of the metal powder-polymer matrix flexible film, the metal powder is attached to one side of flexible film by an adhesive, by extrusion, by hot pressing, by electro-spraying or by cold spraying.

In one aspect, the metal powder-polymer matrix film is formed by extruding the metal powder and polymer mixture. Preferably, the extrusion process is selected from film extrusion, and other processes known the skilled person. Ideally, the metal powder-polymer matrix flexible film is extruded as a continuous roll.

In one aspect, there is provided a method of producing a 3D product using the metal powder-polymer matrix flexible film described above, the method comprising applying the metal powder-polymer matrix film to a build plate; irradiating the matrix flexible film to vaporise the polymer and melt the metal particles together to form a 2D layer; placing a new layer of metal powder-polymer matrix flexible film on top of the previous 2D layer, and repeating the application of the heat source for a number of cycles to produce the desired 3D product. Preferably, the new layer of metal powder-polymer matrix flexible film is either an unused area of the already used flexible film layer or a new layer of metal powder-polymer matrix flexible film. Preferably, the flexible film is delivered to the printing process via a roller system. Ideally, the flexible film is extruded as a continuous roll. The metal powder-polymer matrix flexible film is extruded as a continuous roll that can be placed on a continuous roller in the 3D printer. When printing a 3D product, the roller on which the flexible film is delivered from can be moved relative to the bed on which the build plate is mounted, or the build plate can be moved relative to the flexible film when printing the 3D product.

In one aspect, the metal powder-polymer flexible film is recyclable. When the roll or sheet of flexible film is spent, the remaining scraps of unused material can be recycled and recast or re-extruded into a complete roll or sheet of metal powder-polymer matrix flexible film for use in printing a 3D product.

In one aspect, the metal powder-polymer flexible film is degradable, biodegradable, and/or compostable.

In one aspect, the metal powder-polymer flexible film is one layer thick (for use as a coating) or as multiple of layers stacked one on top of the other (to form a 3D product or part, for example).

In one aspect, the build plate is a weldable metal or weldable plastic.

In one aspect, the matrix film is irradiated by an infrared radiation device, a laser, an electron beam, an arc, a heated plate in contact with the material, or plasma. Preferably, the laser is selected from a CO₂ laser, a 1064 nm infrared Nd:YAG laser, an infrared fibre laser, a diode laser, an argon laser, a krypton laser, an argon/krypton laser, a helium-cadmium laser, a copper vapor laser, a xenon laser, an iodine laser, an oxygen laser, and an excimer laser. Ideally, in the embodiment of the aspects of the invention, the matrix film is irradiated by an ion laser, and preferably an argon laser.

In one aspect, the method of producing the 3D product is selected from the group comprising laser cladding, selective laser melting, selective laser sintering, wire cladding, cold spray, kinetic spray, High-Velocity Oxygen Fuel (HVOF) spray coating, High Velocity Air-Fuel (HVAF) spray coating, plasma spray, arc spray, Direct Energy Deposition (DED), and combinations thereof.

In one aspect, the method of producing the 3D product is by multi-directional printing, wherein the matrix film and source of heat to weld or sinter the film are configured to be rotated though 360° in all dimensions.

In one aspect, there is provided a 3D product produced by the method described above.

It should also be understood that the matrix film and method described above can be used to modify the surface of existing preformed (3D) products or parts. In one aspect, there is provided a method of printing on an existing pre-formed product or part using the metal powder-polymer matrix flexible film described above, the method comprising applying the metal powder-polymer matrix flexible film to the pre-formed product or part; irradiating the metal powder-polymer matrix flexible film to vaporise the polymer and melt the metal particles together to form a 2D layer on the pre-formed product or part; optionally placing the same or a new layer of metal powder-polymer matrix flexible film on top of the previous 2D layer, or on another aspect of the pre-formed product or part, and repeating the application of the heat source for a number of cycles to produce the desired effect on the pre-formed product or part.

The method of printing on an existing preformed product or part is typically by omnidirectional printing, that is, printing from all directions and angles. The printing involved could be used as spot welding, for repairing a pre-formed product or part, for coating a pre-formed product or part, for building features on pre-formed products or parts, adding different metal features on pre-formed products or part, and the like. The omnidirectional method means that the metal powder-polymer matrix flexible film can be applied from all angles, not just up from a build plate upwards.

The matrix film of the claimed invention can be used in a direct energy deposition (DED) process, as a feed stock material. This will allow the user to build structures (of potentially different materials) over existing components of a product that are produced using more conventional manufacturing routes (such as casting, extrusion, forging, machining, etc.). This will also allow the user to print an object from multiple directions, resulting in a potential reduction of final residual stresses on the finished product. The advantages of using this approach as opposed to state-of-the-art powder-blown and wire feed DED, is to be able to achieve a much higher geometrical accuracy, equal to that achievable using SLM process.

The polymer-metal matrix of the claimed invention can be rolled into sheets, drastically reducing storage complexity and cost, removing the need for storage of reactive metals under argon. The polymer-metal matrix allows the use of multiple metals which can be used simultaneously and rapidly in the same build, removing the need to fully clean machines if new materials are needed build-to-build and part-to-part. This removes the ‘rogue particle’ problem which plagues PBF-based processes. This is a significant step-change improvement on current technology capabilities, as this is currently not possible with other powder bed manufacturing methods such as SLM. The method disclosed here allows multi-metal parts to be manufactured rapidly, a first for 3D printing of metals. Post-processing of the polymer and metal via a de-binding and sintering oven is not needed as the parts are fully sintered in the build chamber.

### Definitions

In the specification, the term “sintering” should be understood to mean to coalesce into a solid or porous mass by means of heating without liquefaction. The term “sintering” or “sintered” is also understood to mean “welding” or “welded”, respectively, and the terms can be used interchangeably.

In the specification, the term “matrix”, in the context of the metal-polymer film matrix, should be understood to mean a strip of metal-polymer film formed by melt processing a polymer and metal particles together and being hot pressed.

In the specification, the term “flexible” should be understood to mean that the metal powder-polymer matrix film is capable of bending or flexing easily without breaking.

In the specification, the term “complex structures” should be understood to mean three-dimensional part geometries that cannot easily be manufactured using conventional methods such casting, machining, forging etc.

In the specification, the term “weldable metals” or “weldable thermoplastics (or weldable plastics)” should be understood to mean materials that can be joined together by applying a heat input at the contact interface, achievable also by the inclusion of fillers to facilitate the joining action. In cases where no filler material is added (resistance, electron beam, laser and some autogenous arc welding), the weld metal/thermoplastic has the same composition as the parent material. Where filler materials are added to the weld pool, the composition of the weld metal/thermoplastic (plastic) usually differs from that of the parent material. Examples of weldable metals are steel, stainless steel, titanium, titanium alloys (such as Ti64 or Ti grade 5 and 23), aluminium, aluminium alloys (such Al 6061 and Al 7075), copper, nickel, nickel alloys, super alloys (such as Inconel 625 and 718), high entropy alloys (such as FeCoNiCrMn), cobalt-chrome, barium and molybdenum. Examples of weldable plastics are epoxy, silicone, vulcanised rubber, polyester, polyurethane, polyethylene, polypropylene, polyvinylchloride (PVC), polyvinylidene fluoride (PVDF), fluoroplastics, polyetheramide (PEBA), polyether amide 2533, polylactic acid (PLA), polycaprolactone (PCL), Polybutylene succinate (PBS), polyhydroxyalkanoate (PHA), and poly(3-hydroxybutyrate-co-3-hydroxyhexanoate). Other examples include ceramic-metal composites such as WC—Co and metal-diamond combinations, metal-alumina combinations.

In the specification, the term “build plate” or “metallic build plate” should be understood to mean a surface on which the metal-impregnated polymer sheet/composite is placed on to. The build plate is preferably of the same metal as the powder material, as that will maximise the weldability of the metal-polymer composite. However, the invention is also for multi-material printing, thus combinations of different metals are also possible.

In the specification, the term “polymer sheet architecture” should be understood to mean the structural features of the polymer sheet which accommodate the insertion of the metal particles within the polymer sheet itself.

In the specification, the term “integrated” or “embedded” should be understood to mean where a metal particle is integrated with or embedded in the architecture of the polymer sheet.

In the specification, the term “extrusion” should be understood to mean a process used to create an article of a fixed cross-sectional profile, where the material making up the article is pushed through a die of the desired cross-section. The process can be done with material that is hot or cold.

### Materials and Methods

In the experiments described herein, a steel substrate was chosen as the build base material. On top of it, a commercial tape layer was attached, over one side only (see FIGS. 1a and 1b). At this stage, Stainless Steel powder (SS 316 was used in the experiment) was laid manually over one side of the tape. Whatever portion of powder did not stick to the tape was removed from the area. At this stage, a laser was used to irradiate the area. The laser radiation exposure resulted in two outcomes: (i) removal or partial removal of the polymer layer and (ii) a weld of the powder to the bottom layer. The process was systematically repeated for up to 4 layers of tape in this experiment, resulting in a sintered metal block at the end of the process (see FIG. 3a). The base plate is typically removed after a print, so it does not play a major role into the actual printing process.

### Creating a Metal/Polymer Matrix Composite

In order to reduce the moisture content to a recommended level prior to processing, the polymer material (in this case, PEBAX) and the metal particles (in this case, tungsten particles) were dried in a vacuum oven at 60° C. 40 cm³ of 20% PEBAX2533 and 80% tungsten nanoparticles were blended using a Brabender 50EHT twin screw internal mixer. The metal particle additive was slowly added after a complete polymer melt had formed. The mixer temperature was set at 145° C., the mixing time was for 10 minutes, and the screw rotation speed was 50 RPM. The resulting material was formed into films by thermal compression at 145° C. using a hydraulic press. The polymer was placed between a release film (DuPont™ Melinex®) along with a metal frame to control the film thickness. Once the polymer had melted, the hydraulic press was closed with 90 kN of force which was held for 2 minutes. Cooling was achieved using cold water circulation through the platens while the polymer remained under pressure.

A layer of metal powder is laid on a flat surface. Then, an adhesive polymer is rolled on the powder layer until nothing else appears to stick on it, thus forming the composite.

### Preparation of Metal Binder Sheets for 3D Printing

Metal powder-polymer matrix flexible film (sheet) was fabricated by the solvent casting method using a doctor-blade coating technique, which produced a flexible sheet (film) with uniform thickness and smooth surface properties. The coating paste was prepared by dispersing metal particles into a stock polymer solution and casting the viscous solution over a selected substrate. An immobilized 90° bevelled razor blade was placed on a substrate and the metal powder-polymer solution was dispensed along the sidewall of the blade onto the substrate. The substrate was dragged by a pump at a controlled speed and the blade could then spread the metal powder-polymer solution uniformly on the substrate. After coating, the sample was left in a fume hood at atmospheric pressure for 2 hours for drying. The thickness of the films can be easily controlled from a micron to millimetres by adjusting the gap between the casting knife and the substrate. FIG. 5 depicts the process flow of metal powder-polymer matrix film (sheet) fabrication.

### Printing a 3D Product

The printing of a 3D product can be carried out in a similar manner as to the experiment previously described. 1) a 3D part is firstly produced in a computer-aided design (CAD) format. 2) A software will generate the stereolithography (STL) (or equivalent) file of the part, containing the information for the printing machine to be processed. The STL file also has information in relation to the number of layers the 3D part has been sub-divided into. The metal impregnated polymer sheets would have been separately made, and ready to be used. 3) After placing the first polymer layer over a build plate, a laser (or electron beam) is used to de-bind the polymer matrix and to sinter and/or melt the metal powder to the bottom layer. 4) Then unused sheet is then removed from the area. 5) The procedure is repeated for the required number of layers to form the 3D part.

Automation of the process is envisioned by using, for example, rollers to move the polymer sheet, or multiple polymer sheets with multiple materials, and moved by robotic arms. The building direction can be vertical, horizontal or both. The building direction is vertical in conventional selective laser melting (SLM) and metal 3D Printing, but the vertical direction is not restricted to this in the current invention. It will in fact be possible to selectively decide the build direction by positioning the polymer sheet along the part in a particular orientation or the face that is desired and build another layer/s from there. The current invention is also suitable to 3D print features onto existing parts that are not 3D printed, as opposed to the state of the art.

6) Once the print is finished, the part will be mechanically removed from the build plate and finished with additional processed (if required).

### BRIEF DESCRIPTION OF THE DRAWINGS

The invention will be more clearly understood from the following description of an embodiment thereof, given by way of example only, with reference to the accompanying drawings, in which:—

FIG. 1 illustrates (a) a 2D polymer layer before metal impregnation; and (b) 2D polymer layer after metal impregnation.

FIG. 2 illustrates (a) a polymer-metal matrix and metal build plate underneath laser scanning head; and (b) a sintered and non-sintered metal powder post laser exposure.

FIG. 3 illustrates (a) an optical microscope view of 4 consolidated layers and metal build plate; and (b) a scanning electron microscope (SEM) surface image of a single laser scan showing where powder granules were welded together.

FIG. 4 illustrates tungsten incorporation within a thermoplastic resin produced using the method of the claimed invention.

FIG. 5 is a schematic representation of the solvent casting method of fabricating the metal powder-polymer flexible film of the invention.

FIG. 6 illustrates a titanium-polymer flexible film (sheet) produced by the method depicted in FIG. 5.

FIG. 7 illustrates a thermogravimetric analysis of a stainless steel/PCL metal flexible film (sheet) produced by the claimed method.

FIGS. 8(a) and 8(b) illustrate a scanning electron microscope (SEM) analysis of (a) metal nanoparticles and (b) a metal powder-polymer flexible film (sheet) of the claimed invention.

FIGS. 9(a) and 9(b) illustrate Energy Dispersive X-Ray (EDAX) analysis of a metal powder-polymer flexible film (sheet) of the claimed invention with (a) stainless steel and (b) Ti64 metal particles.

FIG. 10 illustrates SEM images of laser scans over the build plate without any metal powder or any metal powder-polymer flexible film of the claimed invention.

FIG. 11 illustrates SEM images of sintered powder manually laid over a non-heated build plate (top row), and SEM images of sintered metal powder-polymer flexible film of the claimed invention on a build plate (bottom row). An argon laser was used at 90W, with a scan rate of 100, 400 and 700 mm/s.

FIG. 12 illustrates SEM images of sintered powder manually laid over a non-heated build plate (top row), and SEM images of sintered metal powder-polymer flexible film of the claimed invention on a build plate (bottom row). An argon laser was used at 65W, with a scan rate of 100, 400 and 700 mm/s.

FIG. 13 illustrates SEM images of sintered powder manually laid over a non-heated build plate (top row), and SEM images of sintered metal powder-polymer flexible film of the claimed invention on a build plate (bottom row). An argon laser was used at 40W, with a scan rate of 100, 400 and 700 mm/s.

### DETAILED DESCRIPTION OF THE DRAWINGS

The present invention incorporates a novel method of delivering powder in powder bed machines (such as SLM) for use in 3D printing. Metal powder is closely packed and embedded or attached within a thin polymer sheet, whose thickness is slightly larger than the metal powder particles. This thin sheet forms a single ‘2D layer’.

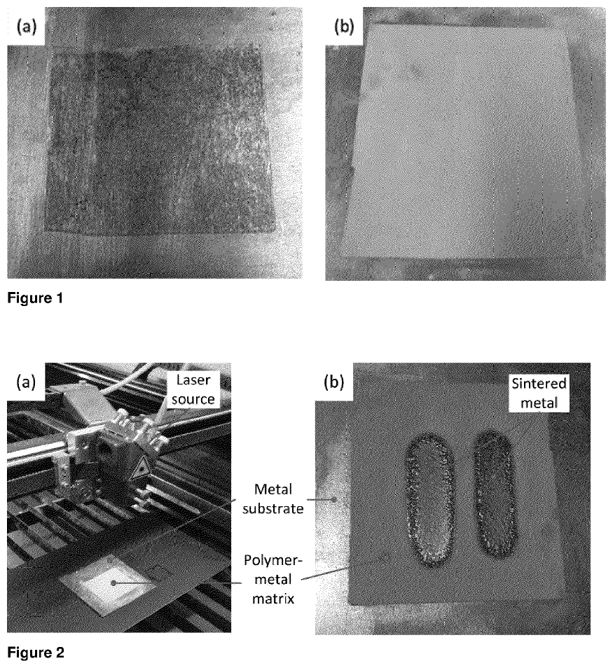

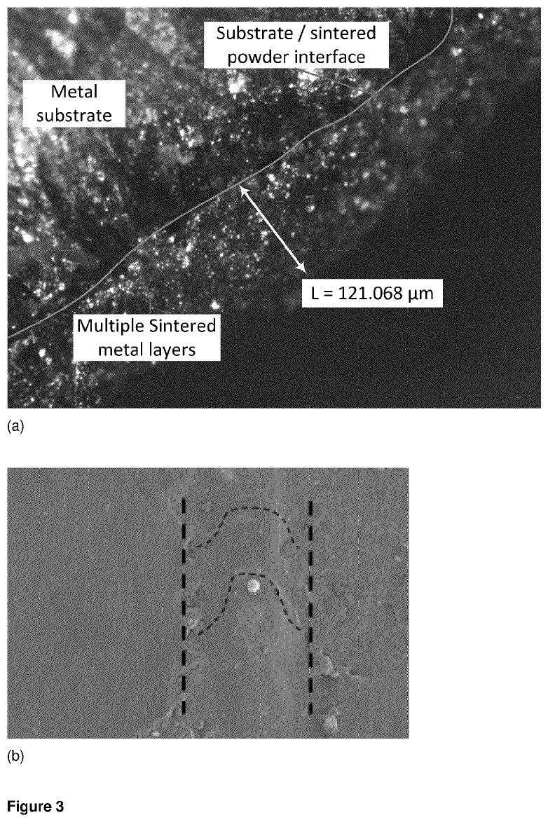

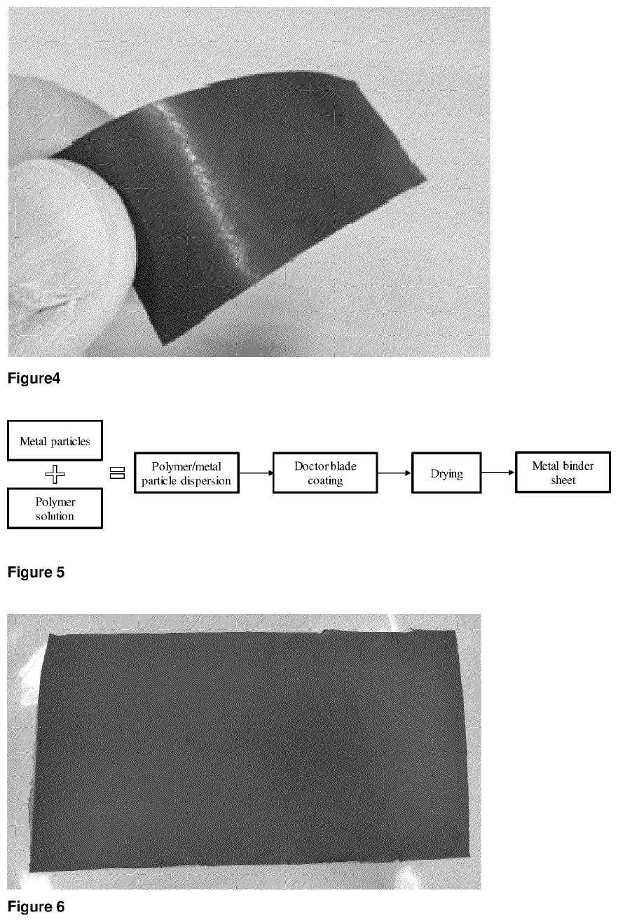

In FIG. 1(a) and FIG. 1(b) demonstrate a 2D polymer layer prior to metal (316L stainless steel) impregnation and after metal impregnation, respectively. Stainless steel particles (d50=30 μm) were first tightly packed and bound within an adhesive polymer sheet, approximately 30-40 μm thick, creating a metal/polymer matrix composite (see FIG. 1(b)). The polymer layer (in this example, polyether amide (PEBA) 2533), after being impregnated, was placed on top of a metallic build plate (see FIG. 2(a)). The polymer-metal matrix was then exposed to a laser beam (in this case a 150W CO₂ laser, with 100 μm spot diameter; a 1064 nm infrared Nd:YAG or fibre laser could also be used) over a small section area (see FIG. 2(b)). This can be a single or multi-pass laser scanning strategy. Upon exposure to the laser beam, the polymer and metal are both irradiated. This causes the polymer to rapidly thermally degrade and vaporise, and the metal particles to rapidly reach melting temperature and weld or sinter together (see FIG. 3(a) and FIG. 3(b)). The laser path determines the shape of the 2D layer that is being built.

Specifically, within the thickness of the first layer that is irradiated, a metal melt pool is formed between the melted powder and a thin section of build plate. Once the laser exposure is removed, these layers cool and solidify almost instantaneously, causing a metallic bonding between the first melted layer and the metal build plate. The next layer of polymer-metal matrix is then placed on top of the first 2D layer. This new layer is also irradiated by the laser using the same parameters, again causing melting of the new layer and several layers underneath (depending on energy density of the laser exposure). This consolidates the new layer to the layers underneath. In this example, the process was repeated 4 times, generating a total printed thickness of approximately 121 μm, as shown in FIG. 3(a). No polymer trace from the sheet was observable in the printed layer and line cross-sections, concluding it had evaporated. If any residual polymer remains on the 2D layer following the single laser pass, the user can apply one or more additional irradiating steps on the formed 2D layer so as to vaporise the residual polymer that remained over from the initial irradiation step. This additional irradiating step(s) may be considered to be a cleaning weld to get rid of any remaining polymer from the formed 2D layer.

FIG. 3(b) shows the results of a number of single laser scans over a same location, starting from a fresh taped powder sheet. It was possible to adjust processing parameters in such a way to completely evaporate the adhesive polymer and weld a “line” of powder (between the dotted black lines in the FIG. 3(b)) onto the build plate. As explained, this process can be repeated until a 3D geometry is fully formed, with each new polymer-metal matrix layer defining a new 2D layer. This process can be used for all weldable metals just as it can be used with conventional PBF.

FIG. 4 shows that it was possible to incorporate micron-sized Tungsten (W) powder within a thermoplastic resin using an extruder to produce a metal incorporation of 80%. The resulting sheet was in this case 80 μm thick, and despite the large W incorporation, kept a high level of flexibility. Whilst the proof of concept was carried out using commercial tape and powder glued onto it, results in FIG. 3 represent a stronger alternative with a greater level of impregnation control and materials choice. The sheet thickness can be also reduced.

### Examples

Example 1: In a typical process, a stock solution of 14 wt. % polycaprolactone (PCL) in chloroform was prepared by dissolving 14 g of PCL in 100 ml of chloroform at room temperature under continuous stirring for 12 hrs. 7.5 g of stainless steel particles (316L) was mixed with 5 ml of PCL solution to create a uniform solution and the solution was spread on a Teflon® substrate using a doctor blade set up as described above. After 2 hrs of drying, the flexible metal powder-polymer matrix film was peeled from the substrate and samples were analysed for mechanical properties, thermogravimetric analysis, scanning electron microscopy and EDAX analysis.

Example 2: In another example, to study the effect of polymer, a stock solution containing a blend of Polylactic acid (PLA)/PCL in chloroform and dimethyl formamide (DMF) solvent prepared by dissolving 14 g of PLA/PCL (80:20 ratio) in 100 ml of a chloroform/DMF (80:20 ratio) mixture at room temperature under continuous stirring for 12 hrs. 7.5 g of stainless steel particles (316L) was mixed with 5 ml of PLA/PCL solution to create a uniform solution and the solution was spread on a Teflon® substrate using the doctor blade set up as described above. After 2 hrs of drying, the flexible metal powder-polymer film was peeled from the substrate and samples were analysed for mechanical properties, thermogravimetric analysis, scanning electron microscopy (SEM) and EDAX analysis.

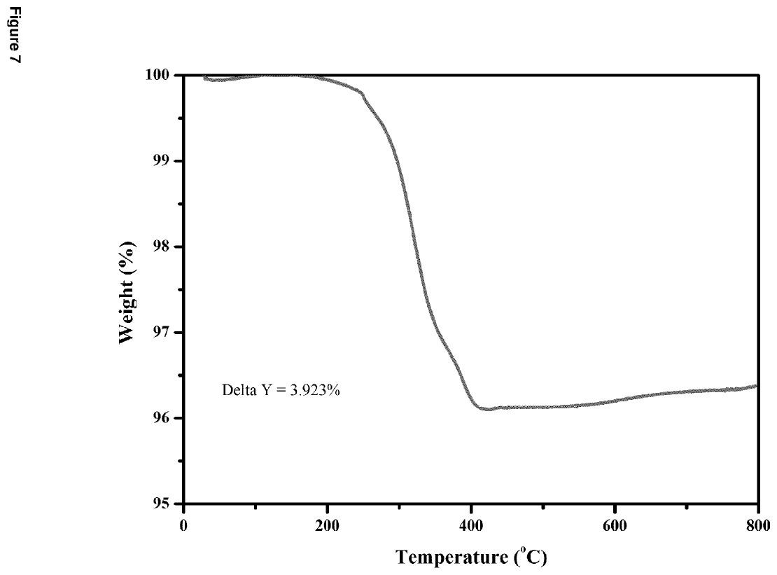

FIG. 6 shows the typical metal powder-polymer flexible film (sheet) produced by the claimed method. Various compositions of stainless steel and titanium particle metal powder-polymer flexible films were prepared with >90 wt % of metal particles. Table 1 shows the composition of films, conditions used to produce and the thickness of the flexible films. Metal powder-polymer flexible film thicknesses from 1 to 300 μm are achievable using the method of the claimed invention.

TABLE 1
Summary of metal-polymer composition,
doctor blade coating conditions and
thickness of metal-binder sheet

| | | PCL | | Average | |
|---|---|---|---|---|---|
| | | polymer | Coating | sheet | |
| Sample | Metal, | solution, | speed, | thickness, | Coating |
| code | g | ml | cm/s | μm | substrate |
| 316L | | | | | |
| S241019 | 7.5 | 5 | 5 | 100 | Teflon ® |
| S251019 | 8 | 5 | 5 | 90 | |
| S041119 | 4 | 5 | 5 | 50 | |
| S061119 | 5 | 5 | 4 | 40 | |
| S071119 | 5 | 3 | 4 | 48 | |
| Ti64 | | | | | |
| T241019 | 7.5 | 5 | 5 | 80 | Teflon ® |
| T211119 | 7.5 | 4 | 4 | 58 | |
| T221119 | 7.5 | 3 | 4 | 58 | |
| T271119 | 15 | 5 | 4 | 90 | |
| T281119 | 30 | 10 | 4 | 95 | |

Thermogravimetric analysis (TGA) was performed on the metal powder-polymer flexible films to find the exact metal content in the films that are produced. FIG. 7 shows the TGA thermogram for metal sheet prepared with 316L stainless steel particles with PCL as binder solution. From the TGA analysis, it is evident that the amount of metal remained at the end of TGA analysis was about 96 wt %, indicating that the films contain >90 wt % of metal.

Table 2 shows the amount of metal content in the various films that are produced. It is evident that all the films have more than 90 wt % of metal content. Raw TGA plots of produced metal powder-polymer matrix flexible films are present in the supporting information. The sheets of the prior art claim a maximum of 80% metal by volume. This is a significantly much lower metal content than the matrix films of the claimed invention. For example, as shown in FIG. 7 and Table 2, the metal content is 96 wt % and polymer is only 4 wt %. This is a significantly increased metal content than that previously obtained by the prior art metal sheets.

TABLE 2
Metal content in the metal powder-
polymer matrix flexible film

| Sample | Metal content, | Polymer content, |
|---|---|---|
| code | wt % | wt % |
| 316L | | |
| S241019 | 95.3 | 4.7 |
| S071119 | 94.3 | 5.7 |
| S121119 | 96.0 | 4.0 |
| S131119 | 97.5 | 2.5 |
| S181119 | 95.3 | 4.7 |
| Ti64 | | |
| T241019 | 91.0 | 9.0 |
| T211119 | 94.4 | 5.6 |

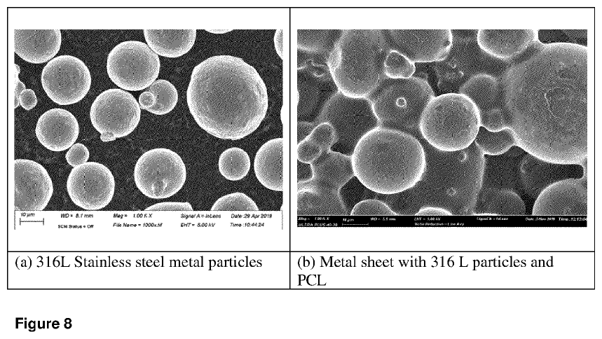

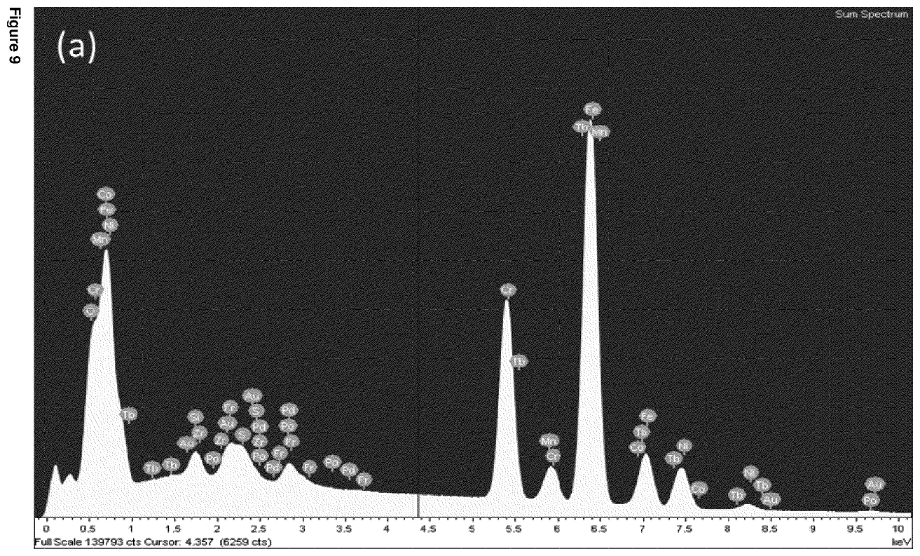

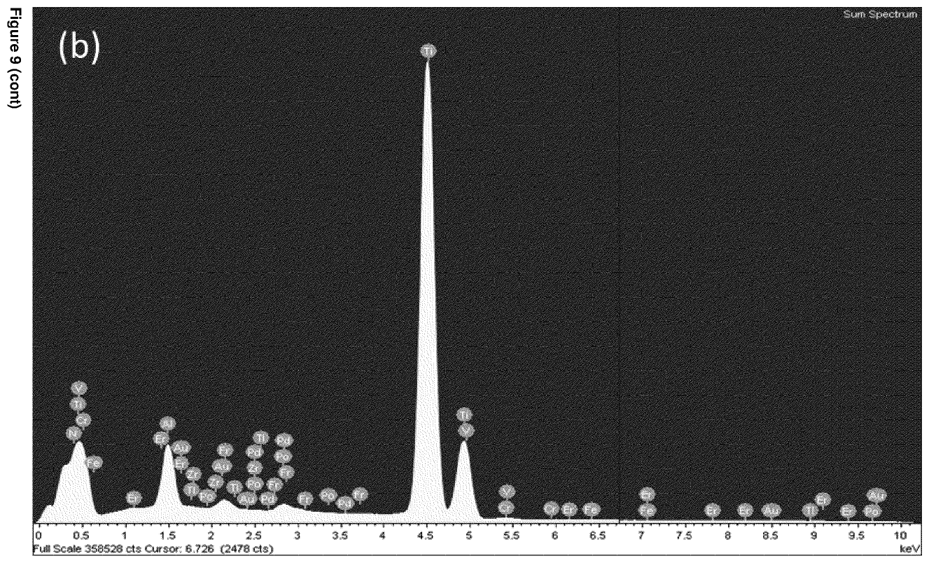

The metals and metal powder-polymer flexible films of the claimed invention were characterised by SEM analysis to evaluate the morphology of the films produced. FIG. 8 shows the SEM analysis of metal nanoparticles and metal powder-polymer flexible films produced. From SEM micrographs it is evident that the metal particles are uniformly coated with polymer (binder). This is important to retain the strength of the film. If polymer is not coated on metal particles this could be weak point and the film mat break during the process. We do not want to have area where there is more or less polymer, this could lead to weld inconsistencies and not uniformity at layers level.

The metal sheets were further analysed by EDAX analysis to confirm the type of metal present in the films. FIG. 9 shows the EDAX analysis of the sheet made with 316L stainless steel and Ti64 metal particles. From the EDAX spectra it is evident that iron is predominant in stainless steel metal powder-polymer flexible film and Ti in Ti64 metal powder-polymer flexible films. The use of EDAX analysis of the film of the claimed invention illustrates, quite clearly, that the metal particles predominate in the film and there is no contamination.

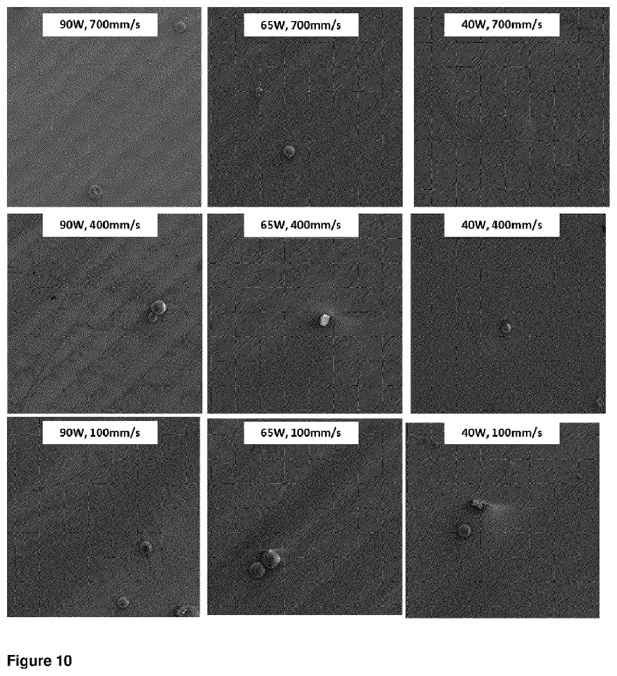

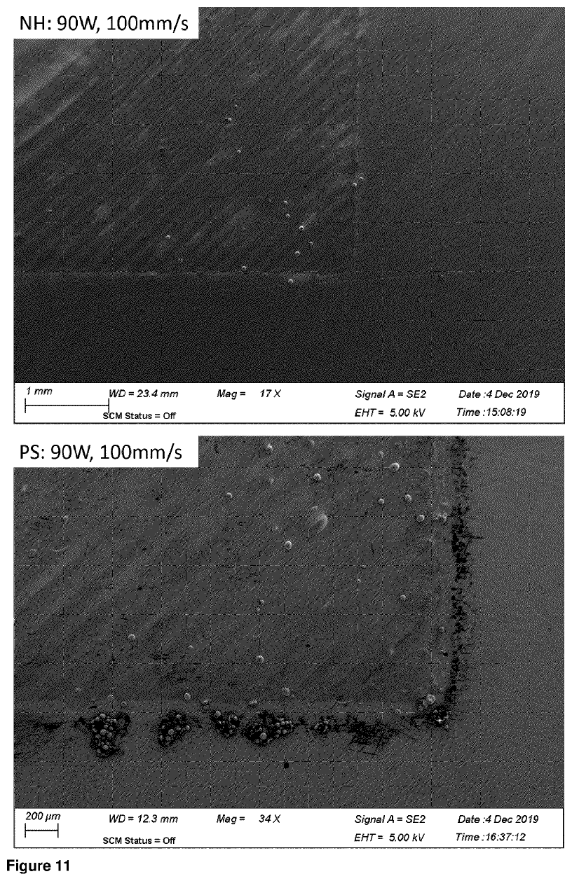

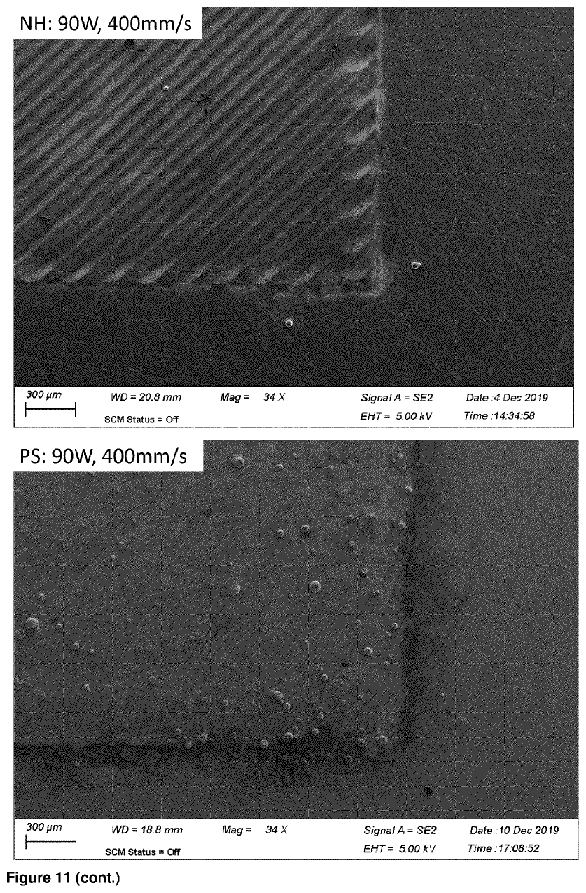

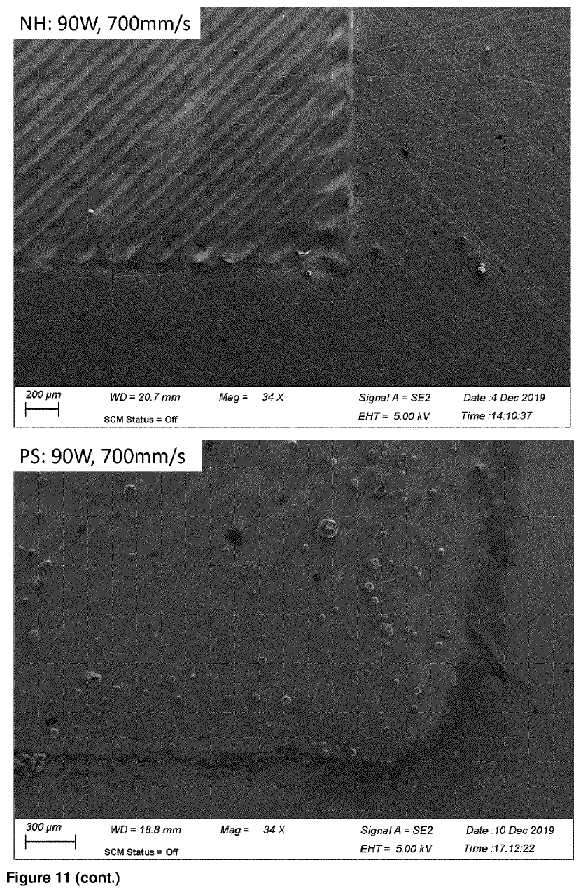

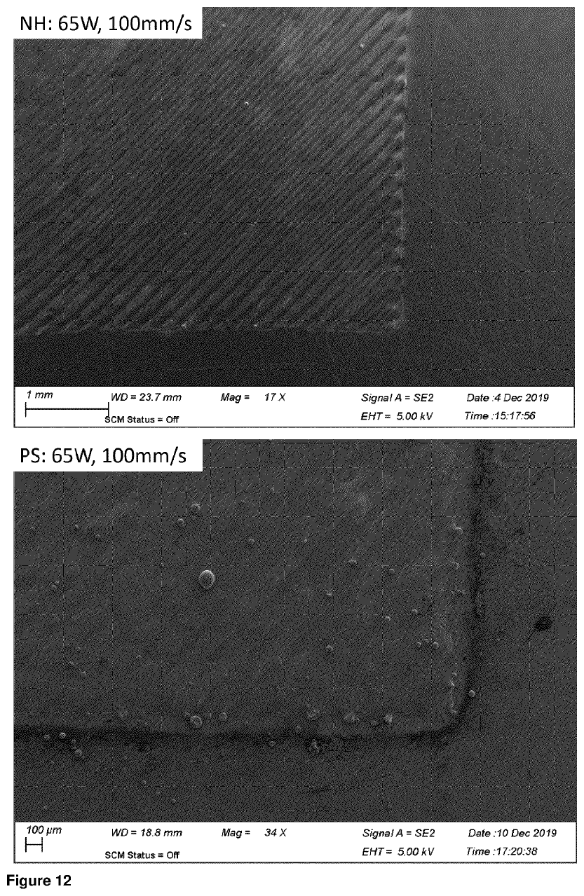

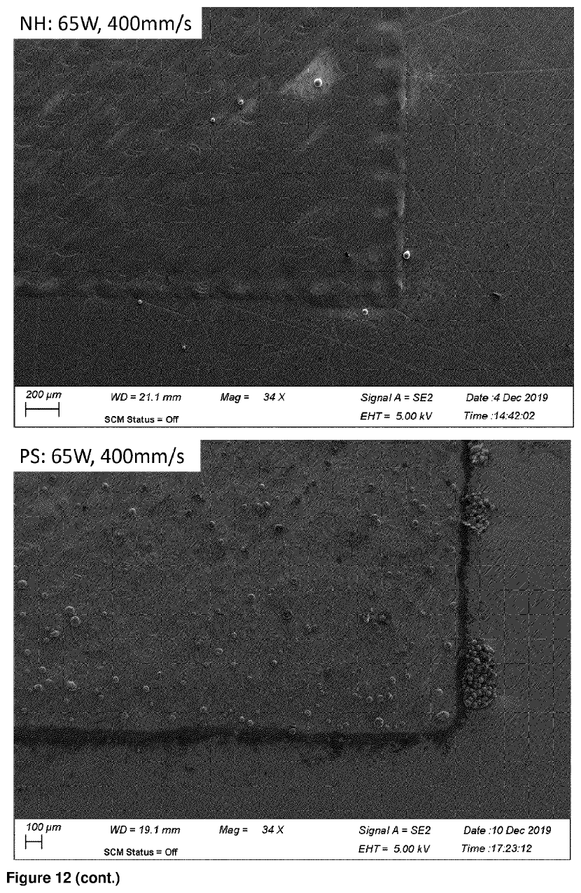

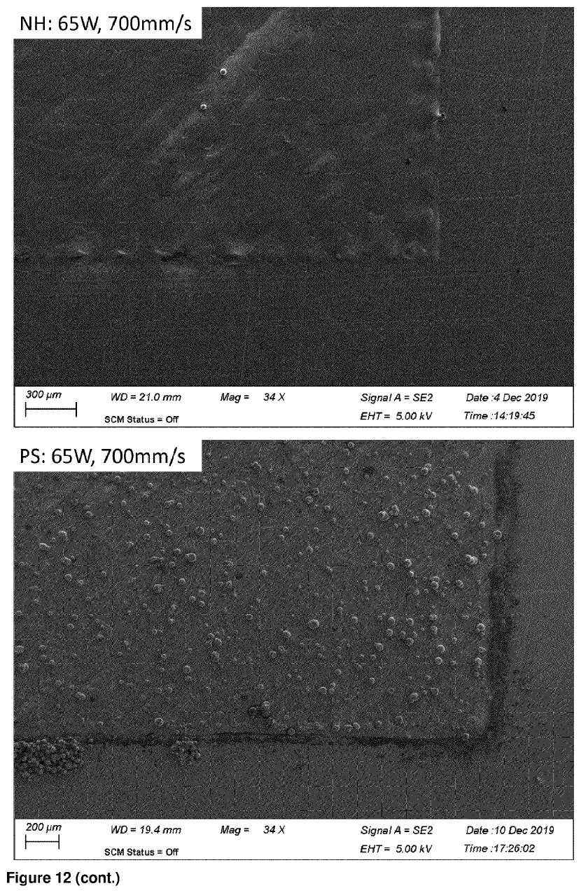

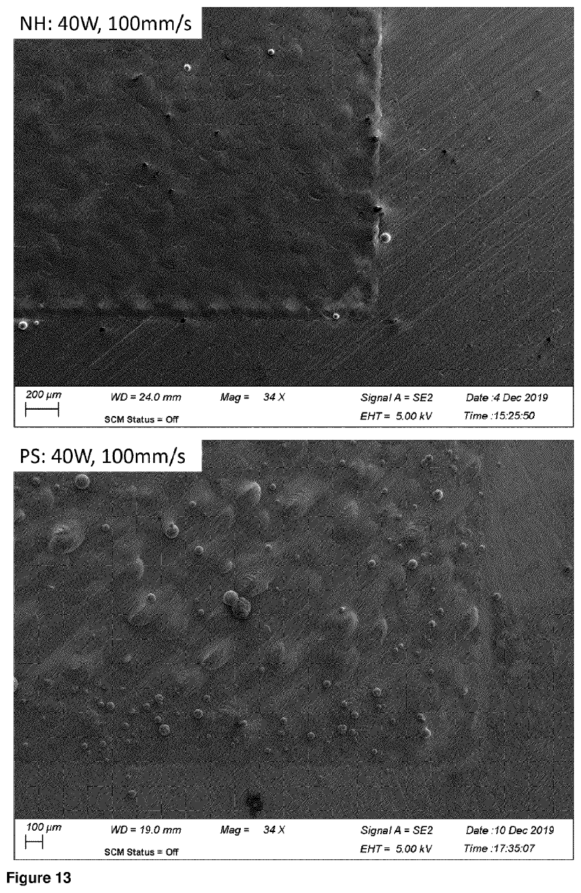

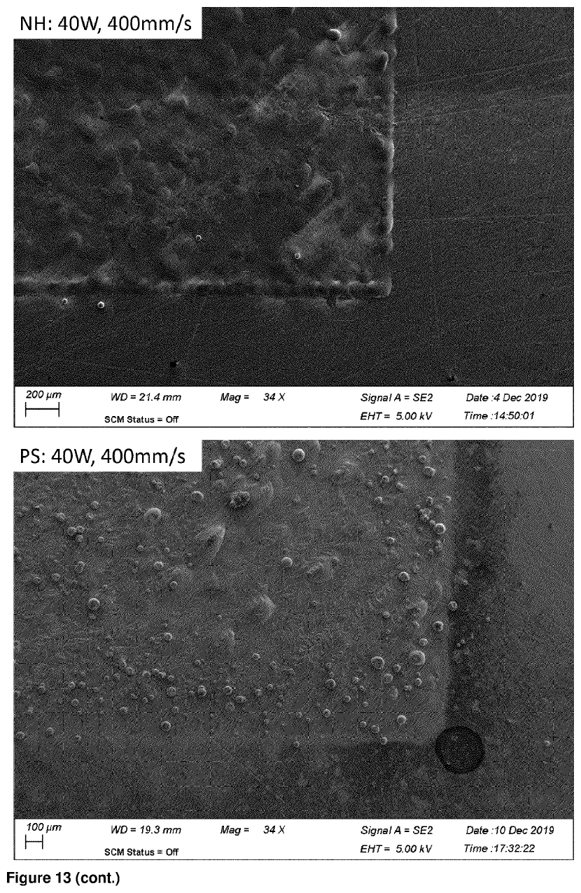

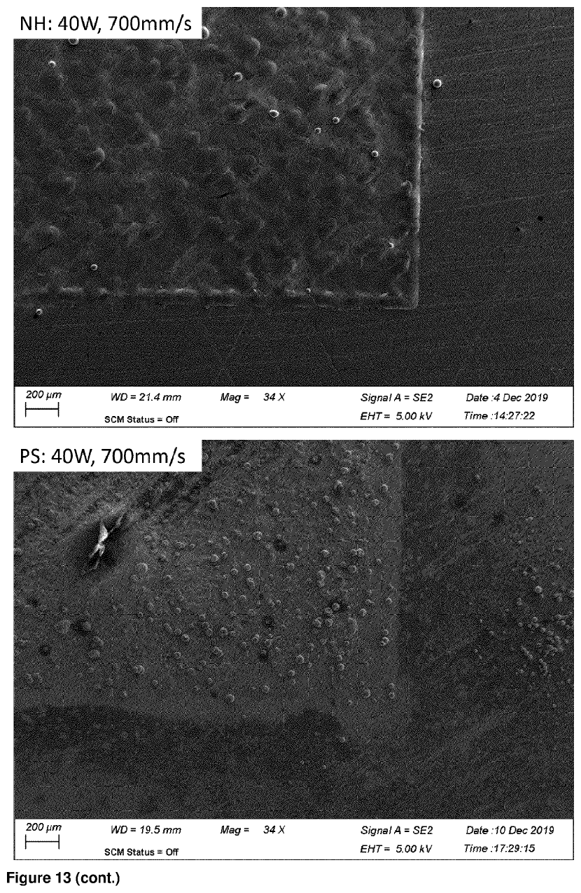

FIGS. 10 to 13 demonstrates that the matrix films and methods of the claimed invention are providing sintered polymer-metal matrix films that produce sintered layers of a standard that is at least comparable to the sintered layers of powder-bed methods and materials of the prior art. The examples in said figures clearly show this. It is clearly possible to observe the layer weld from FIGS. 11-13, as opposed to FIG. 10 where the laser was used without powder, which shows a completely different surface morphology. In all cases, it is possible to recognize the sintered lines from the welding and observe the laser scan patterns (for both manually laid powders and the matrix films of the claimed invention). It can be concluded the mechanism of welding the powder-bed materials and the polymer-metal matrix films of the claimed invention does not change even if the processing parameters are different. This means that the polymer-metal matrix film is not an inhibitor for the weld to take place.

The polymer-metal matrix can be rolled into sheets, drastically reducing storage complexity and cost, and removing the need for storage of reactive metals under argon. The polymer-metal matrix allows the use of multiple metals which can be used simultaneously in the same build, removing the need to fully clean the machine, for example, for the 3D printing of multi-material functional graded components. This is a significant step-change improvement on current technology capability, as this is currently not possible with other powder bed technologies such as in SLM.

The use of the polymer-metal matrix of the invention in a 3D printing process removes the need for PBF-based 3D printing systems, thereby removing a multitude of both safety and technical issues related to powder storage and manufacturing processes. Building time could be greatly reduced in comparison to current PBF processes by using an automated polymer sheet feeder, removing the need for powder layer recoating. Using this technology, each layer thickness will be extremely consistent, improving the stability of current metal 3D printing processes. Binding metal powders in a polymer matrix halts oxygen layer formation on the metal powder surface, improving the chemical stability of the metals, an issue extremely pertinent in safety-critical industries (such as biomedical and aerospace) where oxygen inclusion in the final alloy must be kept to a minimum. In addition:
It could be finally possible to use nano-particles in an SLM process, now prohibitive due to the hazardous danger when large amounts are present and in possible oxygen exposure. Using nano-particles would dramatically reduce the necessary laser power necessary for the weld, hence minimizing residual stresses in the final part (a major problem at the time of writing).
As the layer thickness reduces, it might be possible to achieve powder consolidation with a tailored laser pulse, by emulating the principles of laser shock peening. This would dramatically reduce the working temperatures with clear benefits towards the part quality.
This concept can also help to process materials that are reflective, hence suitable with difficulty for SLM processing (such as copper and aluminium). The polymer sheet can be envisaged to be dark, hence an absorbent with respect to radiation. The heat would be conducted to the powder that is now pre-heated, resulting in a higher absorption coefficient.

The embodiments in the invention described with reference to the drawings comprise a computer apparatus and/or processes performed in a computer apparatus. However, the invention also extends to computer programs, particularly computer programs stored on or in a carrier adapted to control the process and effect the process into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A metal powder-polymer matrix flexible film for use in delivering metal powder to a three-dimensional printing process, the matrix comprising at least one metal powder and a polymer sheet, wherein the metal powder is incorporated within the polymer sheet architecture or on the polymer sheet surface; and wherein the flexible film comprises at least 90 wt % of the metal powder.

2. The metal powder-matrix film of claim 1, wherein the thickness of the matrix is between about 1 μm to about 150 μm.

3. The metal powder-matrix film of claim 2, wherein the thickness of the matrix is between about 5 μm to about 100 μm.

4. The metal powder-polymer matrix film according to any one of claims 1 to 3, wherein the polymer is selected from the group comprising a thermoplastic, epoxy, silicone, vulcanised rubber, polyester, polyurethane, polyethylene, polypropylene, polyamide, polyetheramide, polyvinylchloride (PVC), polyvinylidene fluoride (PVDF), a fluoroplastic, polylactic acid (PLA), polycaprolactone (PCL), polybutylene succinate (PBS), polyhydroxyalkanoate (PHA), and poly(3-hydroxybutyrate-co-3-hydroxyhexanoate).

5. The metal powder-polymer matrix film according to any one of claims 1 to 4, wherein the metal is selected from the group comprising stainless steel, tungsten, titanium, titanium alloys, aluminium, aluminium alloys, copper, nickel, nickel alloys, super alloys, high entropy alloys, cobalt-chrome, barium, molybdenum, NiTi (nitilon), NiTi alloys, ceramic materials, metal-ceramic composites, metal-diamond composites, tantalum, tantalum carbide, and combinations thereof.

6. The metal powder-polymer matrix film according to any one of the preceding claims, wherein the metal powder is embedded within the polymer sheet architecture.

7. The metal powder-polymer matrix film according to any one of claims 1 to 5, wherein when the metal powder particles are closely packed and attached to one side of the polymer sheet.

8. A method of manufacturing the metal powder-polymer matrix flexible film of claim 1, the method comprising the steps of:
mixing the metal powder with the polymer in a ratio of about 4:1 to form a metal powder and polymer mixture; and
forming the metal powder-polymer matrix flexible film.

9. The method of claim 8 for manufacturing the metal powder-polymer matrix flexible claim 1, wherein when the metal powder is incorporated within the polymer sheet architecture, the metal powder-polymer flexible film is formed by solvent casting, thermal hot pressing, extrusion techniques or by joining a number of thin layers of metal-containing polymer sheet together.

10. The method of claim 8 for manufacturing the metal powder-polymer matrix flexible claim 1, wherein when the metal powder is on the surface of the metal powder-polymer matrix flexible film, the metal powder is attached to one side of flexible film by an adhesive, by extrusion, by hot pressing, by electro-spraying or by cold spraying.

11. The method of any one of claims 8 to 10 for manufacturing the metal powder-polymer matrix flexible film of claim 1, wherein the metal powder-polymer matrix film is formed by extruding the metal powder and polymer mixture.

12. The method of claim 11 for manufacturing the metal powder-polymer matrix flexible claim 1, wherein the metal powder-polymer matrix flexible film is extruded by the process selected from film extrusion, and other similar processes.

13. The method of any one of claims 8 to 12 for manufacturing the metal powder-polymer matrix flexible film of claim 1, wherein the metal powder-polymer matrix flexible film is extruded as a continuous roll.

14. A method of producing a 3D product using the metal powder-polymer matrix flexible claim 1, the method comprising applying the metal powder-polymer matrix flexible film to a build plate; irradiating the metal powder-polymer matrix flexible film to vaporise the polymer and melt the metal particles together to form a 2D layer; placing the same or a new layer of metal powder-polymer matrix flexible film on top of the previous 2D layer, and repeating the application of the heat source for a number of cycles to produce the desired 3D product.

15. The method of claim 14, wherein the build plate is a weldable metal or weldable plastic.

16. A method of printing on an existing pre-formed product or part using the metal powder-polymer matrix flexible film of claim 1, the method comprising applying the metal powder-polymer matrix flexible film to the pre-formed product or part; irradiating the metal powder-polymer matrix flexible film to vaporise the polymer and melt the metal particles together to form a 2D layer on the pre-formed product or part; optionally placing the same or a new layer of metal powder-polymer matrix flexible film on top of the previous 2D layer, or on another aspect of the pre-formed product or part, and repeating the application of the heat source for a number of cycles to produce the desired effect on the pre-formed product or part.

17. The method of claim 14, claim 15 or claim 16, wherein the metal powder-polymer matrix film is irradiated by an infrared radiation device, a laser, an ion laser, an electron beam, an arc, a heated plate in contact with the material, or plasma.

18. The method of claim 17, wherein the laser is selected from a CO₂ laser, a 1064 nm infrared Nd:YAG laser, an infrared fibre laser, a diode laser, an argon laser, a krypton laser, an argon/krypton laser, a helium-cadmium laser, a copper vapor laser, a xenon laser, an iodine laser, an oxygen laser, and an excimer laser.

19. The method of any one of claims 14 to 18, wherein the method is selected from the group comprising laser cladding, selective laser melting, selective laser sintering, wire cladding, cold spray, kinetic spray, High-Velocity Oxygen Fuel (HVOF) spray coating, High Velocity Air-Fuel (HVAF) spray coating, plasma spray, arc spray, Direct Energy Deposition (DED), and combinations thereof.

20. The method of any one of claims 14 to 19, wherein the process is performed at atmospheric pressure.

21. The method of any one of claims 14 to 20, wherein the process further comprises an additional step of irradiating the formed 2D layer at least once to vaporise any residual polymer that may be left over from the initial irradiation step.
